(19) United States
(12) Patent Application Publication
(10) Pub. No.: US 2020/0305632 A1
(43) Pub. Date: Oct. 1, 2020

(54) Beverage Brewing Apparatus

(71) Applicant: Trevor F. Kubersky, Kamloops (CA)

(72) Inventor: Trevor F. Kubersky, Kamloops (CA)

(21) Appl. No.: 16/371,079

(22) Filed: Mar. 31, 2019

(51) Int. Cl. A47J 31/00; A47J 31/06

(52) U.S. Cl. CPC A47J 31/005; A47J 31/10; A47J 31/0626

(57) ABSTRACT

A beverage brewing apparatus having a beverage body, a cup, a storage holder and a filter. The beverage body has a tubular body side wall, an open body top end and closed body bottom end to form a beverage chamber. The cup has a tubular cup side wall, a closed cup top end and an open cup bottom end to form a cup chamber. The cup bottom end is removably connected to the body top end. A storage holder has a tubular holder side wall, an open holder top end and a closed holder bottom end to form a holder chamber. The holder top end is removably connected to the body bottom end. The filter is removably connected to the body top end and configured to allow fluid flow between the cup chamber and the beverage chamber.

### REFERENCE TO PENDING APPLICATIONS

This application does not claim the benefit of any issued U.S. patent or pending application.

### TECHNICAL FIELD

The present invention is generally directed toward beverage brewing, and specifically, toward an all-in-one beverage brewing system.

### BACKGROUND

Many coffee drinkers enjoy freshly brewed cups of coffee. However, at times it is difficult to obtain a freshly brewed cup of coffee, such as while a person is traveling or commuting to work.

Accordingly, there is a need for an apparatus and to address the issues set out above.

### SUMMARY

The present invention is generally directed toward beverage brewing, and specifically, toward an all-in-one beverage brewing system. The beverage brewing apparatus is designed to allow for the infusion of a liquid, such as water, with flavors of plant material, such as tea leaves or coffee beans, by the passing of the liquid through the plant material.

In one aspect, a beverage brewing apparatus is disclosed. The beverage brewing apparatus includes a beverage body and a removable filter located within the beverage body. A cup and a storage holder are removably secured to the beverage body. The beverage body has a tubular body side wall, an open body top end and closed body bottom end to form a beverage chamber. The cup has a tubular cup side wall, a closed cup top end and an open cup bottom end to form a cup chamber. The cup bottom end is removably connected to the body top end. The storage holder has a tubular holder side wall, an open holder top end and a closed holder bottom end to form a holder chamber. The holder top end is removably connected to the body bottom end. The filter is removably connected to the body top end and configured to allow fluid flow between the cup chamber and the beverage chamber.

In some aspects, the beverage body has a body external diameter, a body internal diameter, a body external circumference, a body internal circumference and a body height. The cup having a cup external diameter, cup internal diameter, a cup external circumference. In some of these aspects, the cup internal circumference and a cup height, the cup external diameter is equal to the body external diameter. In some aspects, the storage holder has a holder external diameter, holder internal diameter, a holder external circumference, a holder internal circumference and a holder height. In some of these aspects, the holder external diameter is equal to the body external diameter.

In some aspects, the body top end has externally threaded around the body external circumference and the cup bottom end having internal threaded around the cup internal circumference. In these aspects, the threaded body top end and the threaded cup bottom end are threadedly secured to each other.

In some aspects, the body bottom end has externally threaded around the body external circumference and the holder top end has internal threaded around the holder internal circumference. In these aspects, the threaded body bottom end and the threaded holder top end are threadedly secured to each other.

In some aspects, the filter has a substantially circular bowl-shaped wire mesh with a radially extending flange. The flange has a flange diameter that is greater than the body internal diameter but less than the body external diameter. This allows the flange to engage the open top end of the beverage body without extending beyond the side wall of the beverage body, while allowing bowl-shaped wire mesh to extend into the beverage chamber.

In some aspects, the cup has an internal surface, an external surface, an opening for dispensing contents of the beverage brewing apparatus and a flip top for sealing the opening. The flip top may have an elongated body with a first end for opening the flip top and a second end including a flip top pivot secured to the external surface.

Other aspects and features of the present invention will become apparent to those ordinarily skilled in the art upon review of the following description of specific embodiments of the invention in conjunction with the accompanying figures.

### BRIEF DESCRIPTION OF THE DRAWING

In drawings which illustrate embodiments of the invention wherein similar characters of reference denote corresponding parts in each view,

FIG. 1 is a cross-sectional view of an embodiment of the apparatus of the present invention.

FIG. 2 is a cross-sectional side view of an embodiment of the beverage body portion of the apparatus of the present invention.

FIG. 3 is a cross-sectional top view of an embodiment of the beverage body portion of the apparatus of the present invention.

FIG. 4 is a cross-sectional side view of an embodiment of the cup portion of the apparatus of the present invention.

FIG. 5 is a top view of an embodiment of the cup portion of the apparatus of the present invention with the flip top in the closed position.

FIG. 6 is a top view of an embodiment of the cup portion of the apparatus of the present invention with the flip top in the open position.

FIG. 7 is a cross-sectional side view of an embodiment of the storage holder portion of the apparatus of the present invention.

FIG. 8 is a cross-sectional bottom view of an embodiment of the storage holder portion of the apparatus of the present invention.

FIG. 9 is a cross-sectional side view of an embodiment of the filter portion of the apparatus of the present invention.

FIG. 10 is a top view of an embodiment of the filter portion of the apparatus of the present invention.

### DETAILED DESCRIPTION OF THE INVENTION

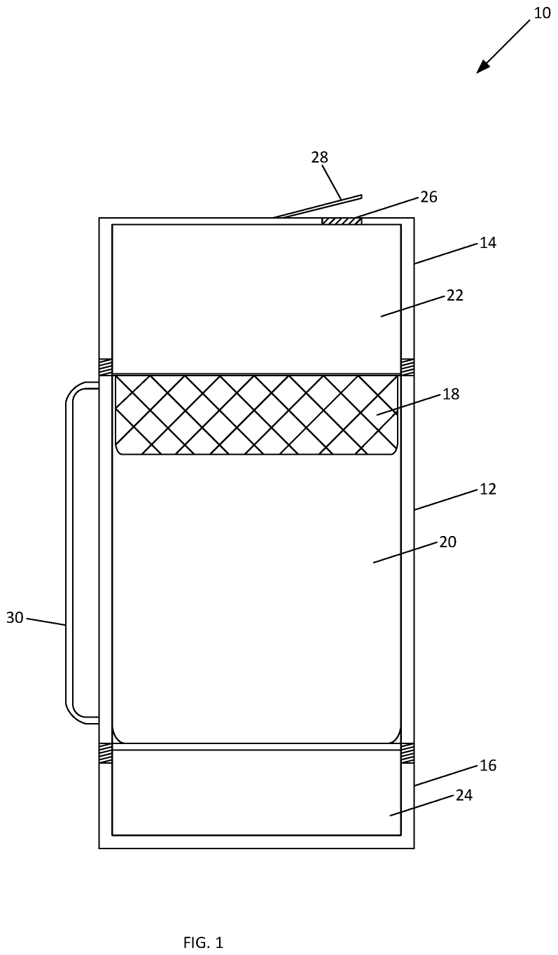

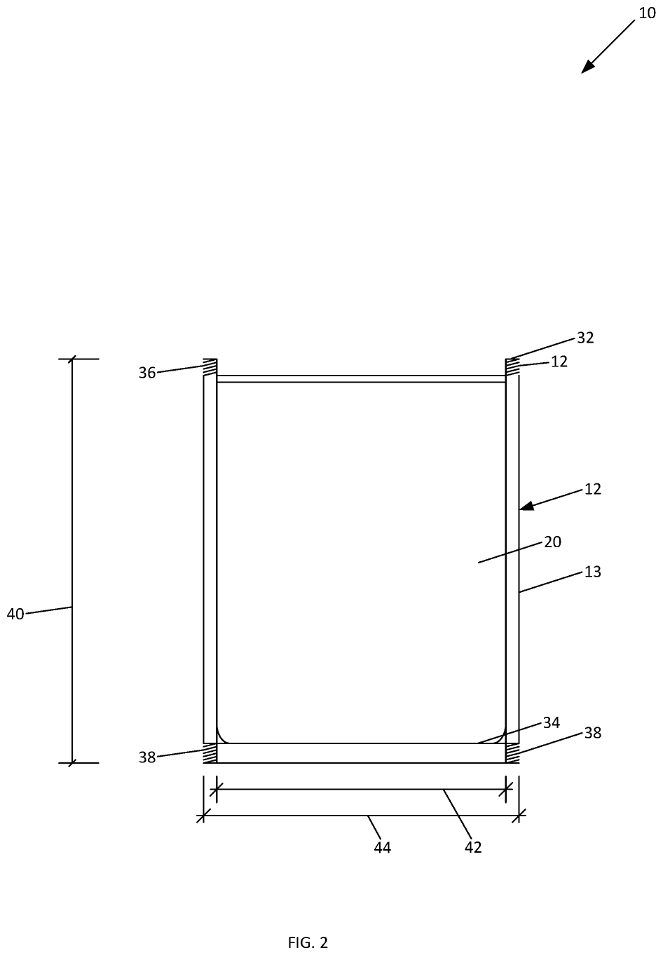

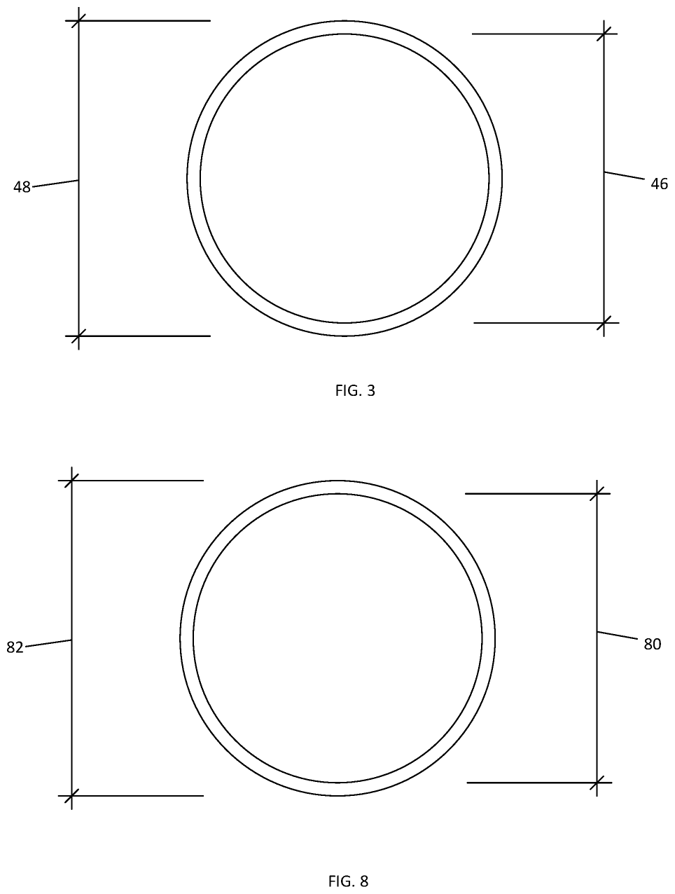

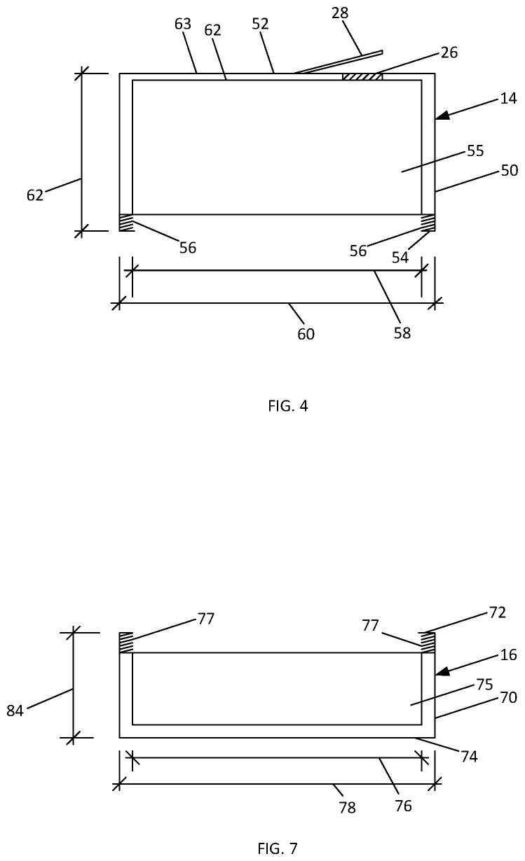

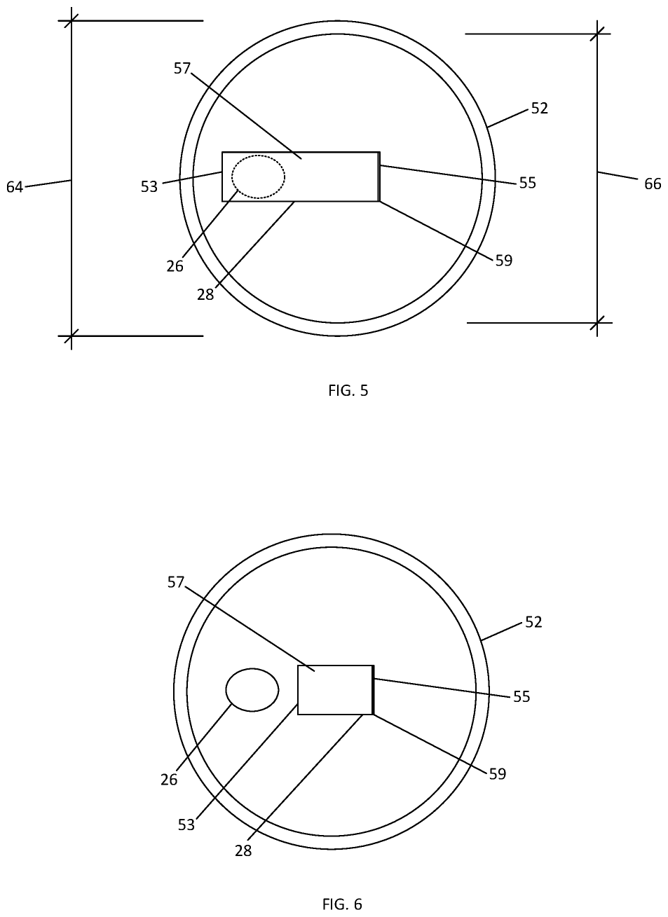

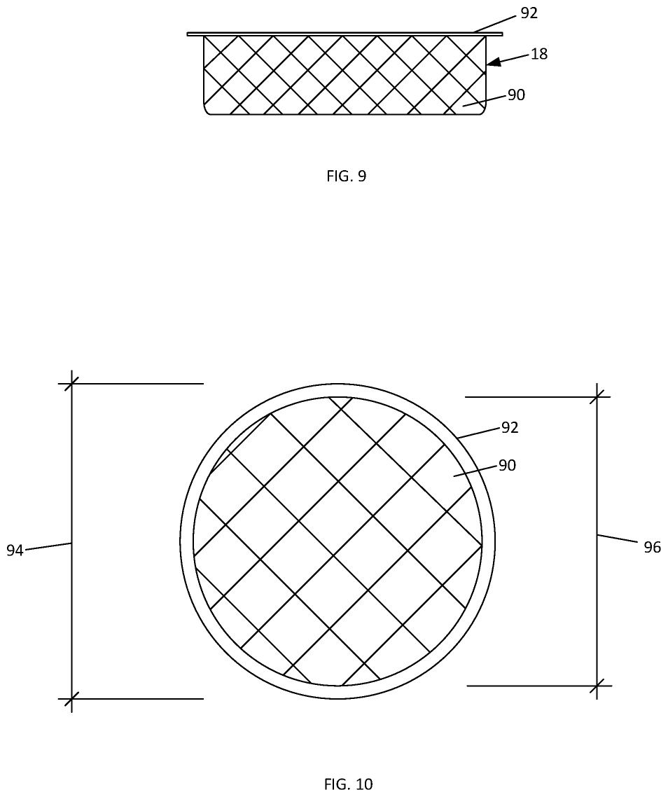

As illustrated in FIGS. 1-10, an embodiment of a beverage brewing apparatus 10 is disclosed. The beverage brewing apparatus 10 generally includes a beverage body 12 having a filter 18 therein. A cup 14 and a storage holder 16 are removably secured to beverage body 12.

Beverage brewing apparatus 10 is designed to allow a person to brew a beverage while traveling or when the person is otherwise away from a conventional countertop coffee maker or coffee shop.

Beverage body 12 has a tubular body side wall 13, an open body top end 32 and closed body bottom end 34 to form a beverage chamber 20. The cup 14 has a tubular cup side wall 50, a closed cup top end 52 and an open cup bottom end 54 to form a cup chamber 55. The cup bottom end 54 is removably connected to the body top end 34. The storage holder 16 having a tubular holder side wall 70, an open holder top end 72 and a closed holder bottom end 74 to form a holder chamber 75. The holder top end 72 is removably connected to the body bottom end 34. The filter 18 is removably connected to the body top end 32 and configured to allow fluid flow between the cup chamber 55 and the beverage chamber 20.

In some embodiments, beverage body 12 is further defined as having a body external diameter 44, a body internal diameter 42, a body external circumference 48, a body internal circumference 46 and a body height 40. Cup 14 is also further defined as having a cup external diameter 60, cup internal diameter 58, a cup external circumference 64, a cup internal circumference 66 and a cup height 62. Storage holder 16 is also further defined as having a holder external diameter 78, holder internal diameter 76, a holder external circumference 82, a holder internal circumference 80 and a holder height 84. In these embodiments, cup external diameter 60 may be equal to the body external diameter 44, while holder external diameter 78 may be equal to the body external diameter 44. This allows for an aesthetic visualization of the external view of the beverage brewing apparatus 10 of being a unitary cylindrical apparatus.

In some embodiments, cup 14 and storage holder 16 are threadedly secured to beverage body 12. In these embodiments, body top end 32 has top external threads 36 that extend around the body external circumference 48 and body bottom end 34 has body bottom external threads 38 that extend around the body external circumference 48. Cup bottom end 54 has cup internal threads 56 that extend around the cup internal circumference 66 and configured to threadedly mate with the top externally threads 36. Further, holder top end 72 has holder internal threads 77 that extend around the holder internal circumference 80 and configured to threadedly mate with the externally threaded body bottom external threads 38. While these embodiments illustrate the inclusion of threads to removably secure cup 14 and storage holder 16 to beverage body 12, such is illustrative. Those skilled in the art will recognize that other removably securing configurations may be utilize and are within the scope of the present invention.

In some embodiments, cup 14 can be constructed from a heat resistant material. This will allow for water to be placed within cup 14 and heated in a microwave oven or other suitable apparatus, while having cup 14 not become deformed or otherwise inoperable.

In some embodiments, filter 18 may include substantially circular bowl-shaped wire mesh 90 having a radially extending flange 92. Flange 92 may have a flange diameter 94 being greater than the body internal diameter 42 but less than the body external diameter 44. This allows flange to engage the open top end 32 of the beverage body 12 without extending beyond the body external diameter 44 of beverage body 12. The bowl-shape of mesh 90 allows for the mesh portion to extend into the beverage chamber 20 and act as a catch, or holder, for the desired plant material, i.e. tea leaves or ground coffee beans. Additionally, filter 18 may include a foldable handle (not shown) to assist with the removal of filter 18 from beverage body 12.

In some embodiments, beverage brewing apparatus 10 may also include a handle 30 that may be to the beverage body 12. Handle 30 assists the user with the ease of carrying beverage brewing apparatus 10. Handle 30 may be collapsible to allow the apparatus 10 to be more streamlined.

In some embodiments, it is desirable to dispense the brewed liquid from within the beverage brewing apparatus 10 without removing cup 14 from the beverage body 12. In these embodiments, closed cup top end 52 of cup 14 may include an internal surface 61, an external surface 63, an opening 26 extending between the internal surface 61 and the external surface 63 and is for dispensing contents of the beverage brewing apparatus 10. To seal opening 26 when not in use, a flip top 28 may be included. When the flip top 28 is in closed position, it forms a watertight seal with opening 26 so that liquid does not leak through opening 26. In some embodiments, flip top 28 may have an elongated body 57 with a first end 53 for opening the flip top 28 and a second end 55 including a flip top pivot 59 secured to the external surface 63.

An example of an embodiment of the operation of the beverage brewing apparatus 10 is illustrated. Prior to operation, it is assumed the filter 18 is engaged with the top end 32 of the beverage body 12 and the cup 14 and storage holder 16 are threadedly secured to the beverage body 12.

In operation, a desired amount of ground coffee beans is placed in the storage holder 16 for use at a later time. The storage holder 16 is threadedly secured to the bottom end 34 of the beverage body 12;

When the user desires, a cup of coffee, cup 14 is detached from beverage body 12. Cup chamber 55 acts a measuring cup and is filled with a desired amount of water. The water may be heated in a microwave oven almost to a boiling point. While the water in cup 14 is being heated, storage holder 16 may be detached from the beverage body 12 allowing access to the stored ground coffee beans. A desired amount of ground coffee beans is placed within the filter 18 that is engaged with the open top end 32 of the beverage body 12. After which, storage holder 16 is threadedly re-secured to the bottom end 34 of the beverage body 12.

Once the water is heated to the desired temperature, it is poured from cup 14 over the ground coffee beans, through the filter 18 and into the beverage chamber 20. After which, cup 14 is threadedly re-secured to the top end 32 of the beverage body 12. Beverage brewing apparatus 10 may be rotated, one or more times, to an upside-down position and back to a right-side up position, to allow the hot water to pass over the ground coffee beans for a desired amount of time in order to create a desired strength of coffee.

Once the coffee has been brewed, the used coffee grounds may be discarded by detaching cup 14 from the beverage body 12 and removing filter 18, which holds the used coffee grounds, removed from beverage body 12. The used coffee grounds are then discarded and filter 18 is reengaged with the top end 32 of the beverage body 12. Cup 14 may be re-secured to beverage body 12.

The user may then gain access to the coffee within the beverage body 12 through an opening 26 in the cup 14 by engaging a flip top 28 that has sealed the opening 26. While this example is directed toward the brewing of coffee and use of ground coffee beans, such is merely illustrative. Those skilled in the art will recognize that other plant material, such as tea leaves, may be used with the present invention.

While preferred embodiments of the present inventive concept have been shown and disclosed herein, it will be obvious to those persons skilled in the art that such embodiments are presented by way of example only, and not as a limitation to the scope of the inventive concept. Variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, and by no means limited by the scope of the claims presented herein.

I claim:

1. A beverage brewing apparatus comprising:
a beverage body, the beverage body having a tubular body side wall, an open body top end and closed body bottom end to form a beverage chamber;
a cup having tubular cup side wall, a closed cup top end and an open cup bottom end to form a cup chamber, the cup bottom end removably connected to the body top end;
a storage holder having a tubular holder side wall, an open holder top end and a closed holder bottom end to form a holder chamber, the holder top end removably connected to the body bottom end; and
a filter removably connected to the body top end and configured to allow fluid flow between the cup chamber and the beverage chamber.

2. The beverage brewing apparatus of claim 1, wherein
the beverage body having a body external diameter, a body internal diameter, a body external circumference, a body internal circumference and a body height;
the cup having a cup external diameter, a cup internal diameter, a cup external circumference, a cup internal circumference and a cup height, the cup external diameter being equal to the body external diameter; and
the storage holder having a holder external diameter, a holder internal diameter, a holder external circumference, a holder internal circumference and a holder height, the holder external diameter being equal to the body external diameter.

3. The beverage brewing apparatus of claim 2, wherein
the body top end being externally threaded around the body external circumference; and
the cup bottom end being internal threaded around the cup internal circumference and configured to being threadedly secured with the externally threaded body top end.

4. The beverage brewing apparatus of claim 2, wherein
the body bottom end being externally threaded around the body external circumference; and
the holder top end being internal threaded around the holder internal circumference and configured to being threadedly secured with the externally threaded body bottom end.

5. The beverage brewing apparatus of claim 4, wherein
the body top end being externally threaded around the body external circumference; and
the cup bottom end being internal threaded around the cup internal circumference and configured to being threadedly secured with the externally threaded body top end.

6. The beverage brewing apparatus of claim 2, wherein the filter is further defined as having a substantially circular bowl-shaped wire mesh with a radially extending flange,
the flange having a flange diameter being greater than the body internal diameter but less than the body external diameter,
the flange configured to engage the open top end of the beverage body,
the bowl-shaped wire mesh configured to extend into the beverage chamber.

7. The beverage brewing apparatus of claim 1, further comprising a handle attached to the beverage body.

8. The beverage brewing apparatus of claim 1, wherein the closed cup top end further defined as having
an internal surface;
an external surface;
an opening for dispensing contents of the beverage brewing apparatus; and
a flip top for sealing the opening, the flip top having an elongated body with a first end for opening the flip top and a second end including a flip top pivot secured to the external surface.
